(19) United States
(12) Patent Application Publication
(10) Pub. No.: US 2023/0171449 A1
(43) Pub. Date: Jun. 1, 2023

(54) PROVIDING FRAME ACCURATE REPLACEMENT SIGNALS IN CONTENT STREAMS

(71) Applicant: Invidi Technologies Corporation, Princeton, NJ (US)

(72) Inventors: Robert Booth, Princeton, NJ (US); Steven Riedl, Princeton, NJ (US)

(21) Appl. No.: 18/060,413

(22) Filed: Nov. 30, 2022

Related U.S. Application Data
(60) Provisional application No. 63/284,544, filed on Nov. 30, 2021.

(51) Int. Cl. H04N 21/258; H04N 21/845

(52) U.S. Cl. CPC H04N 21/258; H04N 21/8456

(57) ABSTRACT

A system and associated functionality are described for identifying, verifying, and replacing insertion opportunity information in content streams. A trigger replacement system (100) for use in an addressable advertising context includes a watermark detector (102) receives a video stream and detects triggers that indicate an insertion opportunity such as watermarks. Information from the watermarks is provided to a logic and decision server (104) that also receives a metadata feed relating to addressable insertion opportunities, assets, and targeting parameters. Once the logic and decision server (104) has processed the watermark information and the metadata feed, the server (104) generates replacement cue information identifying the addressable insertion opportunity. The server (104) can also transmit instructions to a server-side device (110), for example, a server-side ad inserter, a break information server, packager, manifest manipulator, or user device such as a set top box (112) to implement delivery of addressable assets.

### CROSS-REFERENCE TO RELATED APPLICATIONS

This application claims priority to the U.S. Provisional Application No. 63/284,544, filed Nov. 30, 2021, entitled “PROVIDING FRAME ACCURATE REPLACEMENT SIGNALS IN CONTENT STREAMS”. The contents of the above-noted application are incorporated herein by reference as if set forth in full and priority to this application is claimed to the full extent allowable under U.S. law and regulations.

### FIELD OF THE INVENTION

The present invention relates generally to frame signaling in a content stream of a communications network and in, particular, to identifying, verifying, and replacing insertion opportunity information in content streams.

### BACKGROUND OF THE INVENTION

Content streams, such as video content streams of television and streaming networks, may include frame signals for a variety of purposes. For example, in-band or out-of-band signals may be provided in connection with such content streams to identify an insertion opportunity for inserting assets such as overlay information, replacement content, or other content. In this regard, such content may include, for example, local advertisements or addressable advertisements selected for a particular viewer or audience. In such cases, one or more signals within the content stream may identify the insertion opportunity to enable an insertion device, such as a user equipment device or a server-side asset insertion device, to insert the desired content.

The case of addressable asset delivery or addressable advertising is illustrative. Making ad-inventory addressable significantly increases its value for buyers and sellers. Although addressable advertising may be implemented in various ways, in certain systems, addressable advertising is implemented by programming distributors such as MVPDs. MVPDs generally require an SCTE-35 cue message delivered either in-band or out-of-band to trigger frame-accurate dynamic ad insertion for addressable advertising. Traditional methods of triggering replacements based on SCTE-35 cues are not available for dynamic ad insertion systems at certain cable or broadcast local affiliate networks due to the complex, isolated nature of disparate systems holding the identifying data. As a result, addressable advertising has been problematic in certain environments.

### SUMMARY OF THE INVENTION

The present invention is directed to a system and associated functionality for identifying, verifying, and replacing insertion opportunity information in content streams. Such insertion opportunity information can be used to overlay content or replace content in the content stream, for example, to implement addressable asset delivery. The invention thus enables the provision of frame accurate insertion information and enables addressable asset delivery in contexts where such delivery has been problematic.

In accordance with one aspect of the present invention, a method and apparatus (“utility”) is provided for comparing different frame identification information in connection with a content stream of a network. The utility involves operating a network platform to obtain first frame-accurate, insertion opportunity information concerning a first insertion opportunity of a first network content stream and to obtain second insertion opportunity information, from a second source, concerning the first insertion opportunity. For example, the first insertion opportunity information may be obtained from an insertion point detection system. Such an insertion point detection system may, for example, detect and read watermark signals provided in connection with the content stream. It will be appreciated that the watermark signals provide frame-accurate information and may, for example, identify an insertion opportunity for delivering addressable assets. The second insertion opportunity information may, for example, be obtained by reading signal information, such as insertion opportunity cues or other triggers, associated with one or more video frames of the content stream.

The utility further involves obtaining, from the first insertion opportunity information, first presentation time information corresponding to the first insertion opportunity; obtaining, from the second insertion opportunity information, second presentation time information concerning the first insertion opportunity; and performing a comparison of the first and second presentation time information. Based on the comparison, the network platform can manage delivery of the content stream to one or more network users. For example, such management may involve verifying the second presentation time information. Such management may further involve, in response to the verifying, correcting the second presentation time information or providing correction information to an insertion device based on a difference between the first presentation time and a second presentation time.

In accordance with another aspect of the present invention, a utility is provided for use in inserting a replacement signal in a content stream where the replacement signal indicates an insertion point in the content stream for insertion of one or more content assets. The utility involves providing a break description server for providing description information describing an insertion opportunity in connection with the content stream. The break description server is operative to receive, from an insertion detection system, insertion point information concerning an insertion opportunity of the content stream, where the insertion point detection system detects the insertion point free from receiving a cue marker from the content stream. Based on the insertion point information, the break description server is operative to provide the description information regarding the insertion opportunity for use by a network device for managing insertion of content into the content stream in connection with the insertion opportunity. For example, the network device may be a user equipment device or a server-side asset insertion device. As a further alternative, the network device may be a multiplexer for providing the description information together with the content stream of the network. The network device may alternatively comprise a network device operative to transmit a data network message, such as a UDP message, including the description information.

In accordance with a still further aspect of the present invention, a utility is provided for use in delivering addressable assets in a communications network. The utility involves operating a break description server to receive, from an insertion point detection system, insertion point information concerning an insertion point of an addressable insertion opportunity of the content stream, where the insertion point detection system is operative for detecting the insertion point free from receiving a cue marker from the content stream. Based on the insertion point information, the break description server is operative to provide option information regarding the addressable insertion opportunity for use by a network device managing insertion of one or more addressable assets into the content stream in connection with the addressable insertion opportunity. In this manner, addressable asset delivery is enabled even where cue marker information is not provided in the raw content stream.

In accordance with another aspect of the invention, a utility is provided for handling in-band and/or out-of-band insertion information. The utility involves providing an adapter for generating insertion opportunity description information describing an insertion opportunity in connection with a content stream of network. The adapter is operative to receive, from an insertion point detection system, first insertion opportunity information concerning a first insertion opportunity of the content stream, where the insertion point detection system is operative to detect the first insertion opportunity independent of (e.g., free from or without reference to) receiving a cue marker from the content stream. The adapter is further operative receive second insertion opportunity information from the content stream of the network concerning a second insertion opportunity that may be the same as or different from the first insertion opportunity. The adapter is then operative to provide the description information, based on at least one of the first and second insertion opportunity information, for use by a network device for managing insertion of content to the content stream.

In accordance with another aspect of the present invention, a utility is provided for use in delivering addressable assets to network users whereby playlists can be timely and accurately provided to different user equipment devices receiving programming via different formats or modalities and/or via different systems. The utility involves an asset delivery opportunity (ADO) identification system for identifying ADOs in connection with programming and an asset decision system for making determinations concerning what assets individual user devices should deliver in connection with specific ADOs and providing playlists to the individual user equipment devices. The ADO identification system receives 1) schedule data concerning scheduled ADOs and 2) real-time information about upcoming ADOs in programming as presented in one or more network environments. The ADO identification system is then operative for correlating the upcoming ADOs with the scheduled ADOs and identifying, to the asset delivery system, an upcoming scheduled ADO. In this manner, the asset decisioning system can provide accurate playlists to the user equipment devices for a scheduled ADO regardless of differences in ADO timing dependent on specific network environments.

### BRIEF DESCRIPTION OF THE DRAWINGS

For a more complete understanding of the present invention and further advantages thereof, reference is now made to the following Detailed Description, taken in conjunction with the drawings, in which:

FIG. 1 is a schematic diagram of a trigger replacement system for use in an addressable advertising context in accordance with the present invention;

FIG. 2 illustrates a system diagram in accordance with the present invention where a detection device detects insertion points such as cue points within the video stream and then recreates the content provider cues to be sent out-of-band to the adapter for reintroducing those cues to the network's stream of cues and associating them with the addressable inventory;

FIG. 3 shows an implementation where the adapter receives other triggers such as SCTE-35 content distributor cues from a multiplexer using defined interfaces in accordance with the present invention;

FIG. 4 is a flow chart that illustrates certain implementations of the process of FIG. 3;

FIG. 5 shows a break information service system in accordance with the present invention;

FIG. 6 is a schematic diagram of a system for correlating observed avails to scheduled avails to implement addressable asset delivery in accordance with the present invention; and

FIG. 7 is a flow chart illustrating a process for correlating observed avails to scheduled avails to implement addressable asset delivery in accordance with the present invention.

### DETAILED DESCRIPTION

The present invention relates to identifying, verifying, and replacing insertion opportunity information in content streams. Existing or proposed techniques for replacing missing trigger information, such as cues, do not fully account for the needs of dynamic ad insertion. In one implementation, the present invention addresses the signaling triggering problem using information from watermarks to replace the missing or ambiguous frame-accurate SCTE-35 cues or other triggers and recombine them with the existing distributor cues and associate them with addressable inventory for dynamic ad insertion for an MVPD. Although the invention is described herein in connection with certain television or video streaming networks, as well as associated VOD contexts, it will be appreciated that the invention is applicable in other network environments including, for example, internet audio, satellite, and/or radio networks.

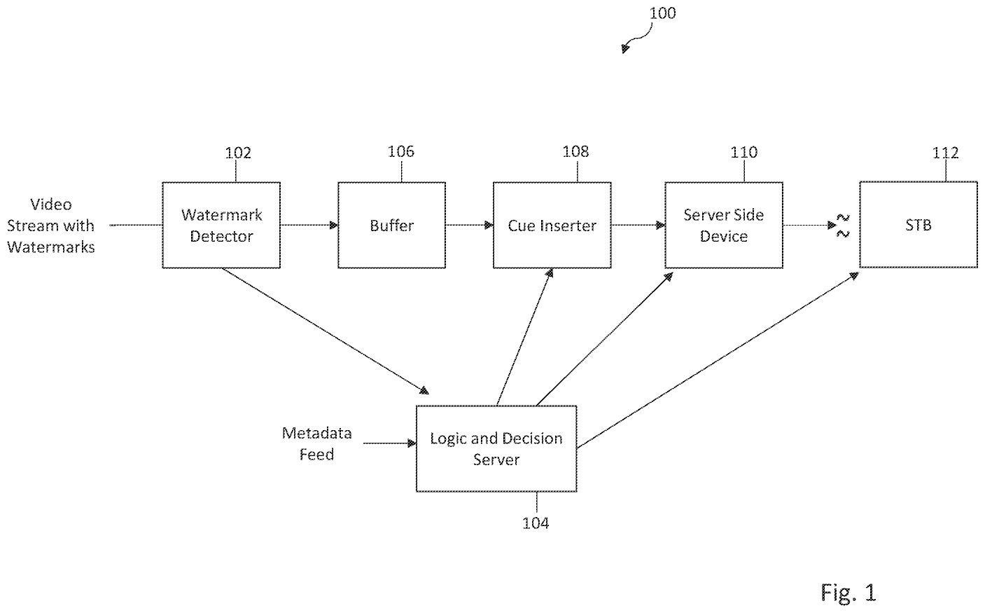

FIG. 1 is a schematic diagram of a trigger replacement system 100 for use in an addressable advertising context. In the illustrated system 100 a trigger detector such as a watermark detector 102 receives a video stream with triggers to indicate an insertion opportunity such as watermarks. The detector 102 detects and reads the watermarks to identify an insertion opportunity such as an ad break or in-programming ad insertion opportunity. Information from the watermarks is provided to the logic and decision server 104 that also receives a metadata feed relating to addressable insertion opportunities, assets, and targeting parameters. Such metadata may be obtained from a second source such as a platform of a content distribution network, a scheduling system or the like.

In the illustrated system 100, a buffer 106 or similar device is used to introduce a delay to facilitate insertion of replacement cues. Once the logic and decision server 104 has processed the watermark information and the metadata feed, the server 104 generates replacement cue information identifying the addressable insertion opportunity among other things. The server 104 can also transmit instructions to a server-side device 110, for example, a server-side ad inserter, a break information server, packager, and/or manifest manipulators, and/or user equipment devices such as set top boxes 112 to implement delivery of addressable assets to specific viewers or audiences.

One or more of the illustrated elements 102, 104, 106, and 108 (as well as other elements described in the embodiments below) may be implemented on one or more network platforms. It will be appreciated that such platforms may be executed on one or more machines (e.g., computers or servers) at a single site or geographically distributed. Each such site may execute the full functionality of the noted elements the functionality may be distributed across sites. Moreover, the functionality may be distributed in various ways between such platforms, associated user devices, and any other platforms, e.g., some preprocessing of information may be executed at the user devices or other platforms, for example, to facilitate rapid response or reduce use of processing resources of the platform or communication bandwidth requirements. The platforms may be hosted by a system provider or may be implemented separately (e.g., cloud-based) and connected to the system provider via an interface such as API.

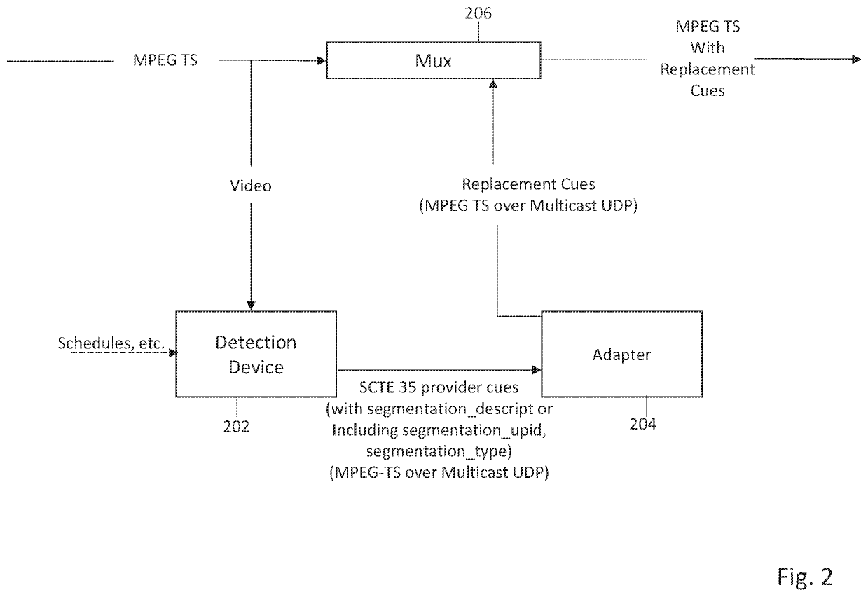

Specific implementations of such a system may leverage certain existing components provided by various parties. FIG. 2 is a system diagram where detection device 202 (such as the BlackBox device of Adcuratio), detects insertion points such as cue points within the video stream even though the SCTE-35 cue markers have been stripped, and then recreates the content provider cues to be sent out-of-band to the novel adapter 204 (which may be embodied in INVIDI's Edge™ product) for reintroducing these cues to the network's stream of cues and associating them with the addressable inventory. The most common way to send cues out-of-band is through a pre-configured Multicast UDP channel as shown, but other transmission paths/modalities could also be used.

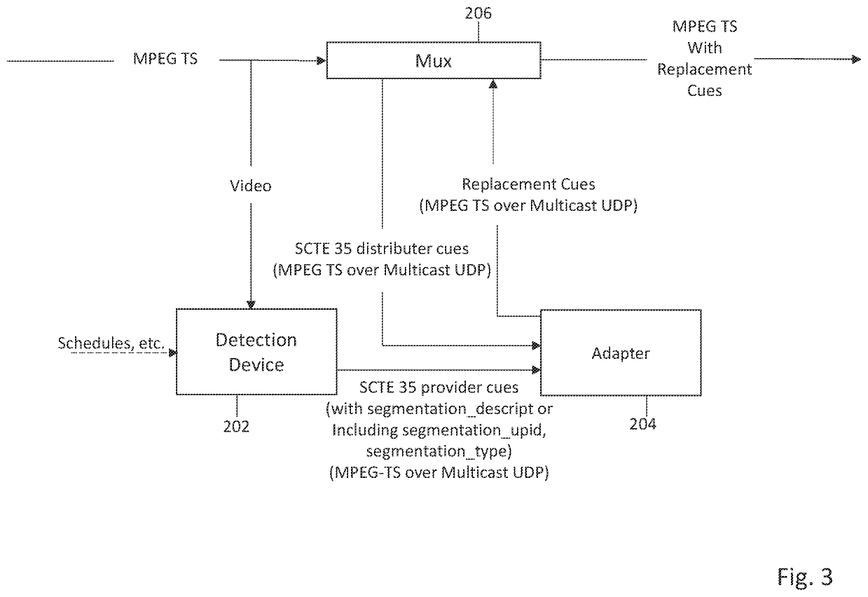

In addition to the out-of-band content provider cues being received from the detection device 202, the adapter 204 may continue to receive other triggers such as SCTE-35 content distributor cues from the multiplexer 206 using defined interfaces as shown in FIG. 3. Hence, FIGS. 2-3 show two use-cases of a break description server. The adapter 204 processes cues from one or both sources, and subsequently sends novel replacement cues (and other private data) downstream for ad insertion on set-top boxes or SSAI (Server-Side Ad Insertion) devices. By using this approach, the illustrated system creatively resolves the issue of potential lost ad opportunities due to cues being stripped.

The dynamic ad insertion technology using out-of-band cues and reintroducing those to the network cue stream to associate with addressable inventory makes it possible to extend addressable advertising to provider avails on affiliate networks which remove the distributor cues, thus making this inventory much more valuable to providers and advertisers because multiple ads individually selected by each device based on its targeting can be played in the same avail. Existing watermark products provide the technology to fingerprint the original network video and recreate the provider cue information and the adapter 204 enables integration of this new method of receiving cues into addressable advertising infrastructure, associating both these cues and distributor cues with addressable inventory and selecting the most appropriate addressable ads. Thus, an insertion device, such as a user equipment device or SSAI, may receive the replacement cue and use the cue to request a playlist from an asset decision system. The asset decision system can then identify the addressable asset delivery opportunity, identify an appropriate asset, such as an ad, for delivery in connection with the asset delivery opportunity, and transmit a playlist of one or more assets to the insertion device. For example, this may involve identifying the assets available to be played in the addressable asset delivery opportunity and targeting information (such as demographics or other targeting parameters) for the assets, identifying the classification parameters of the user equipment device or current audience, matching the targeting information to the classification parameters, identifying campaign information (e.g., relating to total number of impressions, frequency, pacing, etc. relating to asset delivery), and using all of this information to generate a playlist.

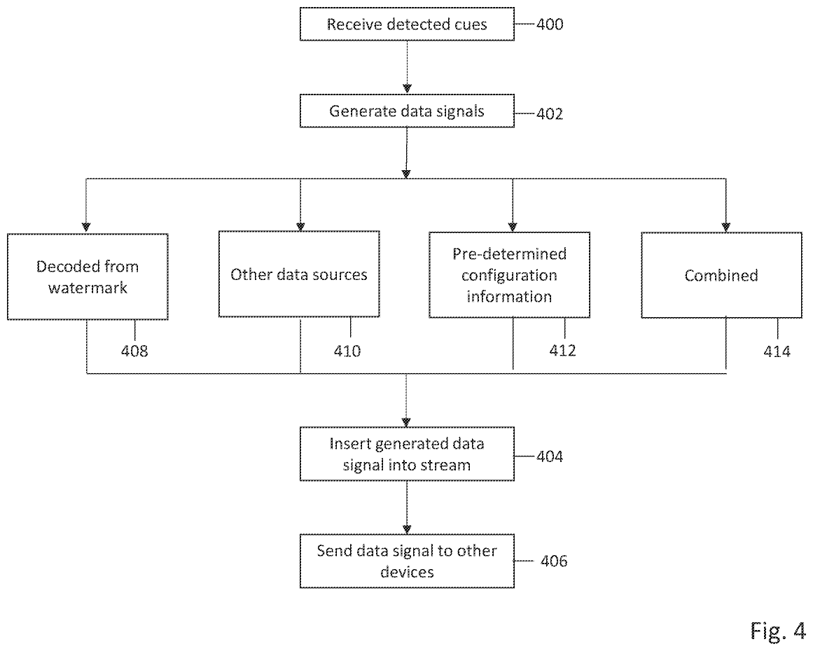

FIG. 4 is a flow chart that illustrates certain implementations of this process.
1. Detected content provider triggers are received (400) from the detection device that, for example, detects watermarks or similar triggers;
2. The received triggers are used to generate (402) data signals;
3. Generated data signals can be inserted (404) into single-cast, multicast, or broadcast transmission signals; and
4. Generated data signals can be sent (406) to other devices, equipment, or services for further processing/utilization.
5. The process can eliminate or reduce the need for head-end capital equipment that is expensive to purchase, maintain and support; and
6. The process can enable new revenue streams for currently deployed legacy set-top boxes and also for over-the-top streaming applications and services.
7. Information to include in the data signal can be derived from: a) information (i.e.—identifiers or other data) decoded from the watermark (408) b) other data sources (410) c) pre-determined configuration information (412) or d) any combination (414) of a, b, and c.

### Use of Advertisement Watermarks to Generate or Check Other Ad Signaling Mechanisms

Certain implementation may use a video watermark for a television monitor to determine when replaceable content is playing so that the system can optionally overlay that content with other content. By the nature of the watermark used it is frame accurate and exists for the entire duration of the content with a frame counter embedded so the total duration can also be checked. Some programmers use other methods of signaling replaceable content such as SCTE-35 signaling or Automated Content Recognition. These implementations may use the watermarks to either verify that the other signaling is still accurate, or to insert other in or out of band signaling if it does not exist. When verifying other signaling, some of the other signaling methods are prone to failures in the insertion of the signaling so that it is no longer accurate. Most broadcasters use multiple broadcast chains for redundancy. A broadcaster would typically switch chains when repairing or improving the other chain, then switch back. These changes can affect the timing of the signal and many broadcasters have no way to detect that this is off. Since the inserted signal should be pointing to the first frame of the watermarked ad, a system can detect if that signal is still correct and either attempt to fix the signal, use an adjusted signal in internal methods or notify the programmer that the signaling is no longer accurate. Some programmers have not built out the infrastructure to insert SCTE 35 signaling, or that signaling may not make it through to an affiliate or other system in the program flow from the programmer to the insertion location. By using the watermark and possibly some out of band metadata such as SCTE 224, a signal similar to an SCTE 35 message can be inserted back into the stream, or the systems that would normally be notified of the SCTE 35 message could have that notification happen out of band. Another use for the watermark is that the current signaling mechanisms do not correlate to a specific ad, just that an ad is inserted at a specific time. By using the watermark and having a locally unique code, systems can verify that the correct ad is being run. Another use is if the content is stored on a Digital Video Recorder it would typically lose the non-video signaling information, but the watermark will be recorded with the ad and could be used on playback as well (e.g., to replace ads with addressable ads appropriate to the playback time and audience).

The description above includes implementations for effectively converting from watermarks, or other indications of an insertion opportunity, to insertion messages such as SCTE 35 cues, and this has numerous advantages as described above. It will be appreciated that, in certain contexts, it may be desired to perform other conversions and the invention can be applied for such purposes. For example, it may be desired to convert from insertion messages such as SCTE 35 cues to watermarks or other indications of an insertion opportunity. In such cases, the cue message may be read to obtain information concerning an insertion opportunity and then a watermark writer or similar device may be operated to write watermarks or other markers into the content stream to indicate the insertion opportunity. Similarly, it may be desired to re-insert the original SCTE 35 or other cue message in the stream. In such cases, the newly created replacement message may be deleted from the content stream and the original cue, or a re-created version thereof, may be inserted into the stream. In general, the processes of the present invention can be used to support a wide variety of trigger or cue conversions as desired.

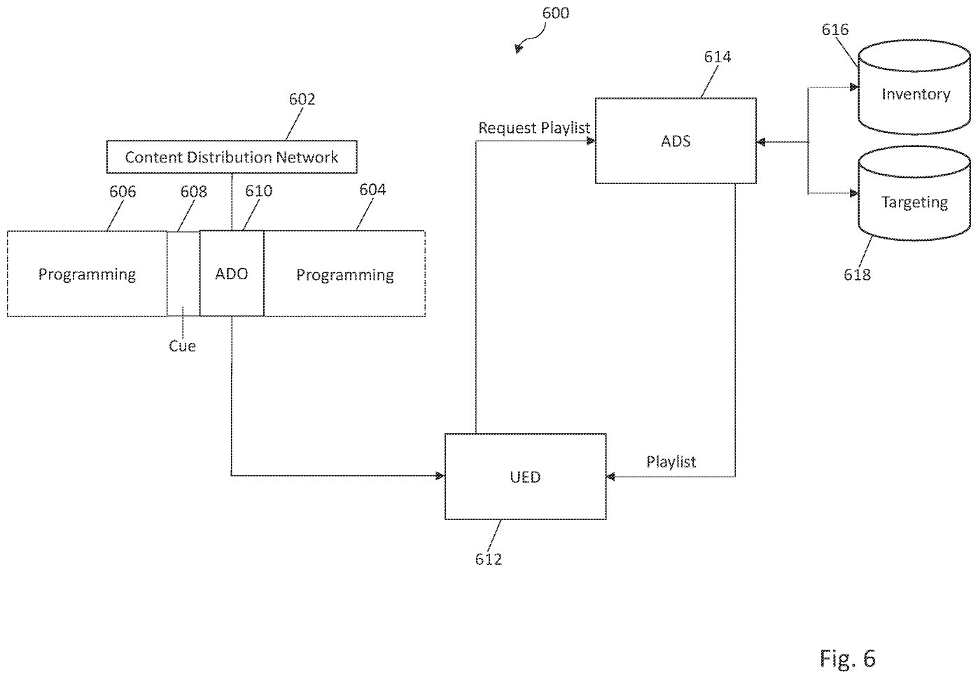

Referring to FIG. 6, in various addressable asset delivery contexts, a user equipment device 612—such as a set-top box in broadcast television networks or a smart TV, tablet computer, laptop, or other data device in streaming contexts—may obtain asset delivery instructions (e.g., a playlist) from an asset decision system (ADS) 614. For example, in connection with an upcoming addressable asset delivery opportunity (ADO) 610 (which may be identified by a cue 608) in programming 604 and 606 of a given programming network or in connection with streaming programming, the user equipment device 612, may request a playlist from the ADS 614. The ADS 614 can then provide a playlist for that user equipment device 612 accounting for, among other things, the inventory available for that ADO 610 and targeting parameters/delivery constraints, the demographics or other classification parameters associated with the user equipment device 612 or a current audience, campaign parameters including pacing and frequency, and device parameters such as recency of asset delivery and total number of impressions delivered for specific assets.

To provide accurate playlists, it is important that the ADS receive timely and accurate information about the next addressable ADO. However, when programming 604 and 606 is being delivered to user equipment devices 612 in different formats using different systems, delays in playback may be introduced. For example, stream packagers may introduce delays of 30-40 seconds or more in the broadcast distribution pipeline relative to the original MPEG2 broadcast programming handled by set-top boxes. This may make it difficult for the ADS to match the next addressable ADO to available inventory for the correct scheduled ADO.

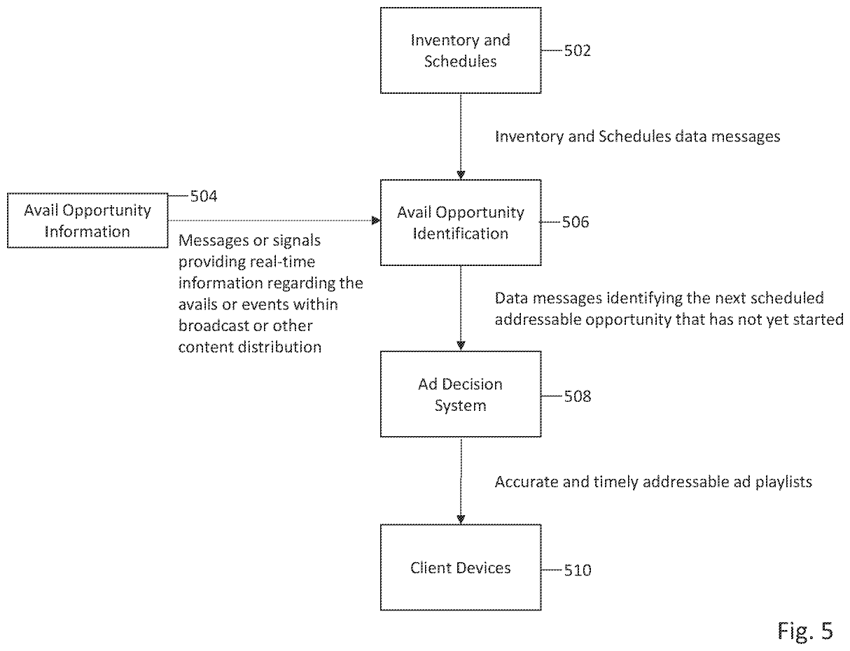

FIG. 5 shows a break information service system 500 in accordance with the present invention. For convenience, the system 500 is described in relation to programming breaks, e.g., interruptive ad breaks in programming, but it will be appreciated that other types of asset delivery opportunities may be supported such as overlay ads, product placement ads, and PSAs. The system 500 includes an avail opportunity identification module 506 that receives inputs from an inventory and schedules module 502 and from an avail opportunity information module 504 and provides outputs to the ADS 508. Specifically, the module 506 receives inventory and schedule data messages from the module 502. These messages may indicate, for example, what breaks in which programming are addressable, when those breaks are scheduled, and what assets are available for playing in those breaks as well as what targeting parameters/delivery constraints are associated with those assets.

The available opportunity identification module 506 also receives messages or signals providing real-time information regarding the avails or events within broadcast programming or other content distribution. These messages or signals may be based on cue messages, watermarks as described above, or other in-band or out-of-band information concerning avails or events. This information may indicate an avail and include timing information for the avail as presented in the broadcast programming or programming stream. The avail opportunity identification module 506 is then operative to correlate an upcoming avail as reflected in the data from the avail opportunity information module 504 to a scheduled avail as indicated in the messages from the inventory and schedules module 502. In this manner, the module 506 can identify the upcoming break indicated by the avail opportunity information module 504 and provide an output to the ADS 508 identifying that avail. The ADS 508 can then provide playlists to client devices 510 appropriate for that break and for each of those devices/audiences.

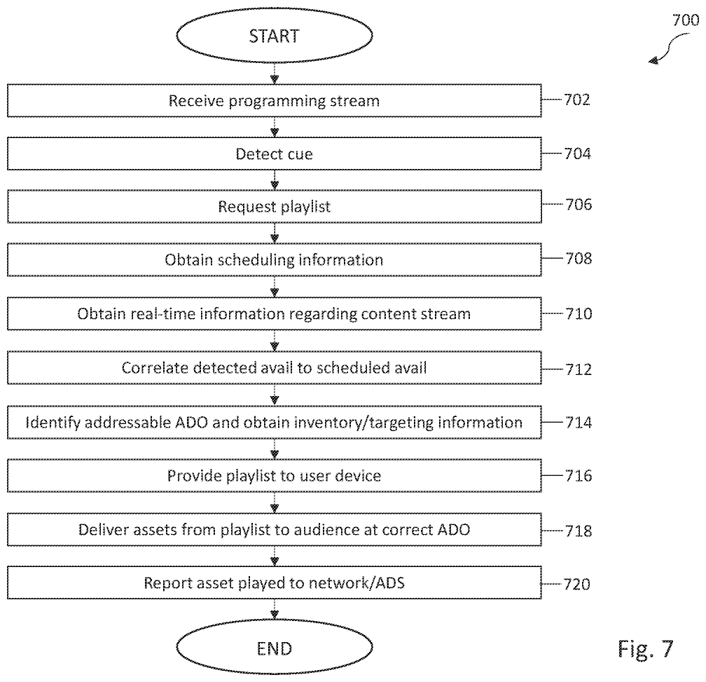

FIG. 7 is a flowchart illustrating a process 700 for correlating observed triggers or cues to scheduled ADOs to enable appropriate and accurate delivery of addressable assets such as addressable ads. The illustrated process 700 is initiated by receiving (702) a programming stream at a user equipment device such as a set-top box or a streaming device. The user equipment device may then detect (704) a cue in the programming stream identifying an upcoming ADO. As noted above, the cue observed by the user equipment device may occur at a different time than scheduled in certain network environments. In some cases, the cue may be corrected or replaced as described above before being received by the user equipment device. In response to the cue, the user equipment device may request (706) a playlist from an ADS.

To correlate the observed cue to a scheduled ADO, the ADS may obtain scheduling information (708) from a content delivery network. For example, the scheduling information may indicate how many ADOs are provided in the relevant programming, when the ADOs are scheduled to occur, and which ADOs are addressable. The ADS may also obtain (710) real-time information regarding the content stream. Such real-time information may be provided by cues, watermarks as described above, or other triggering signals. The ADS can then correlate (712) the observed or detected avail to a scheduled avail. That is, the ADS can correlate the real-time information regarding the content stream to scheduled information concerning addressable ADOs. This correlation process may make use of ADO information provided in connection with replacement cues as described above.

Once the ADS has correlated the detected avail to a scheduled avail, the ADS can identify (714) the appropriate addressable ADO for the playlist request and obtain inventory information and targeting information. Based on the available inventory for the addressable ADO and targeting information (e.g., targeting parameters of the user equipment device or current audience, campaign information such as total number of impressions, frequency and pacing, and any other targeting information or constraints), the ADS can identify appropriate assets and provide (716) a playlist to the user device. The user device can then deliver (718) assets from the playlist to the audience of the user equipment device at the correct addressable ADO. Finally, the user equipment device may report (720) delivery of the asset(s) played to the content delivery network and/or the ADS. Such reporting may be used for billing, to track campaign fulfillment, and for other purposes.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

1-6. (canceled)

7. A method for use in inserting a replacement signal in a content stream, said replacement signal indicating an insertion point in said content stream for insertion of one or more content assets, said method comprising:
providing a break description server for providing description information describing an insertion opportunity in connection with the content stream of a network;
first operating said break description server to receive, from an insertion point detection system, insertion point information concerning an insertion point of said insertion opportunity of said content stream, wherein said insertion point detection system is operative for detecting said insertion point independent of receiving a cue marker from said content stream;
based on said insertion point information, second operating said break description server to provide said description information regarding said insertion opportunity for use by a network device for managing insertion of content into said content stream in connection with said insertion opportunity.

8. The method of claim 7, wherein said break description server is further operative for receiving a cue marker indicative of said insertion point from said content stream.

9. The method of claim 8, wherein said break description server is operative to provide said description information based on both said insertion point information and said cue marker.

10. The method of claim 7, wherein said network device is a user equipment device of said network.

11. The method of claim 7, wherein said network device is a server-side asset device such as an ad inserter, break information server, a packager, or a manifest manipulator.

12. The method of claim 7, wherein said network device is a multiplexer for providing said description information in connection with said content stream of said network.

13. The method of claim 7, wherein said network device is operative to transmit a data network message including said description information.

14. The method of claim 7, wherein said data network message is a UDP message.

15. The method of claim 7, further comprising using said description information to identify an addressable asset delivery opportunity of said content stream.

16. The method of claim 15, further comprising, selecting an asset to deliver in connection with said addressable asset delivery opportunity.

17. The method of claim 16, wherein said selecting comprises matching an audience classification of an audience of a user equipment device to targeting parameters of said asset.

18. An apparatus for use in inserting a replacement signal in a content stream, said replacement signal indicating an insertion point in said content stream for insertion of one or more content assets, said system comprising:
a break description server for providing description information describing an insertion opportunity in connection with the content stream of a network;
said break description server being operative for:
receiving, from an insertion point detection system, insertion point information concerning an insertion point of said insertion opportunity of said content stream, wherein said insertion point detection system is operative for detecting said insertion point independent of receiving a cue marker from said content stream; and
based on said insertion point information, providing said description information regarding said insertion opportunity for use by a network device for managing insertion of content into said content stream in connection with said insertion opportunity.

19. The apparatus of claim 18, wherein said break description server is further operative for receiving a cue marker indicative of said insertion point from said content stream.

20. The apparatus of claim 19, wherein said break description server is operative to provide said description information based on both said insertion point information and said cue marker.

21. The apparatus of claim 18, wherein said network device is a user equipment device of said network.

22. The apparatus of claim 18, wherein said network device is a server-side asset device such as an ad inserter, break information server, a packager, or a manifest manipulator.

23. The apparatus of claim 18, wherein said network device is a multiplexer for providing said description information in connection with said content stream of said network.

24. The apparatus of claim 18, wherein said network device is operative to transmit a data network message including said description information.

25. The apparatus of claim 18, wherein said data network message is a UDP message.

26. The apparatus of claim 18, further comprising an asset decision system for using said description information to identify an addressable asset delivery opportunity of said content stream.

27. The apparatus of claim 26, wherein said asset decision system is further operative for selecting an asset to deliver in connection with said addressable asset delivery opportunity.

28. The apparatus of claim 27, wherein said selecting comprises matching an audience classification of an audience of a user equipment device to targeting parameters of said asset.

29-32. (canceled)
